(19) United States
(12) Patent Application Publication
(10) Pub. No.: US 2016/0123371 A1
(43) Pub. Date: May 5, 2016

(54) FASTENING MEANS, ASSEMBLY AND METHOD

(71) Applicant: JOHNSON CONTROLS TECHNOLOGY COMPANY, Holland, MI (US)

(72) Inventors: Frederic T. Winters, South Lyon, MI (US); Steve E. White, Farmington Hills, MI (US); Dean E. Cigut, Clay Township, MI (US); Andrew J. Erard, Ceresco, MI (US); Kenneth R. Grubaugh, Howell, MI (US)

(21) Appl. No.: 14/893,151

(22) PCT Filed: May 28, 2013
(86) PCT No.: PCT/US2013/042836

§ 371 Date: Nov. 23, 2015

(51) Int. Cl. F16B 37/00; B21C 23/00

(52) U.S. Cl. CPC F16B 37/00; B21C 23/00

(57) ABSTRACT

The invention relates to a fastening means provided for engaging with factional or positively locking means in a friction or positively locking fashion comprising a protuberance realized as an extrusion, wherein the protuberance projects from a plate expanding along a main plane and having a prime surface facing away from the protuberance and comprises an inner side, wherein the inner side forms a circle having an inside diameter Di in a plane being parallel to the main plane, wherein a first plane being parallel to the main plane includes a circle with the first inside diameter Di′ and a second plane being parallel to the main plane includes a circle with the second inside diameter Di″, and wherein the first plane is closer to the prime surface than the second plane, and wherein the first inside diameter Di′ is greater than the second inside diameter Di″.

### FIELD

The invention relates to a fastening means provided for engaging with frictional or positively locking means in a friction or positively locking fashion.

### BACKGROUND

Such fastening means are well known and are usually provided and designed for engaging with frictional or positively locking means such as a screw, in particular a thread roiling screw. Typically the height of the protuberance is equal or greater than the diameter of the frictional or positively locking means, for example the diameter of the screw. At the same time the inner side of the protuberance usually has straight sides, i. e. walls forming the protuberance realize a cylinder substantially, in particular a straight hollow cylinder. Another feature of such fastening means known from the prior art is the throat that links the inner side of the protuberance with the prime surface of the plate, wherein the radius of the circle segment is about 1.25 times greater than the thickness of the plate/material the protuberance was made from,

Although these fastening means known from the prior art are popular in diverse areas of engineering such as fastener engineering, their use is potentially restricted by defects on the surface of the protuberance, in particular defects on the surface of the inner side of the protuberance. Such defects are mainly caused by the straight sides and the protuberance height being equal or bigger than the diameter of the locking means. More specifically, both features, namely straight sides and protuberance height, make it difficult to release a die easily whenever the die is forming the inner side of the protuberance. A possible method to circumvent these defects is keeping the press speed at a minimum in order to minimize the creation of unwanted defects.

### SUMMARY

It is an object of the present invention to provide a fastening means that can be realized such that defects on the surface of the inner side can be avoided mainly and nevertheless the time of manufacturing is still reasonable.

The object of the present invention is solved by a fastening means provided for engaging with frictional or positively locking means in a friction or positively locking fashion (, like for an example a screw) comprising a protuberance realized as an extrusion. According to the present invention it is provided that the protuberance projects from a plate expanding along a main plane and having a prime surface facing away from the protuberance. The protuberance comprises an inner side, wherein the inner side forms a circle having an inside diameter Di in a plane being parallel to the main plane. According to the present invention it is further provided that a first plane being parallel to the main plane includes a circle with the first inside diameter Di′ and a second plane being parallel to the main plane includes a circle with the second inside diameter Di″, wherein the first plane is closer to the prime surface than the second plane. According to the present invention the first inside diameter Di′ is greater than the second inside diameter Di″. By this a tilt angle or draft angle on the inner side of the protuberance is realized, advantageously. In more detail the advantage of the fastening means according to the present invention is the reduction of surface defects potentially located on the inner side of the protuberance, because the die can be released in an easier fashion (compared to a protuberance with straight side). Along with this positive effect, the press speed of manufacturing the protuberance can be increased, advantageously. Since tools are required less by the generating of the protuberances according to the present invention, another positive effect of the present invention is the extending of the tool life of the tools producing the protuberance.

### BRIEF DESCRIPTION OF THE DRAWINGS

FIG. 1 shows a sectional view of a fastening means according to an embodiment of the present invention.

FIG. 2 shows geometrical fundaments regarding a tilt that is realized whenever a protuberance is designed according to the present invention.

### DETAILED DESCRIPTION

According to a preferred embodiment it is also provided that the protuberance has an opening. Advantageously, such an opening allows using the fastening means bidirectionally, i. e. for example a screw can be inserted into the fastening means along a direction showing in the direction of the protuberance or in opposite direction. Additionally it is also conceivable that the inner side of the protuberance comprise a thread.

According to another embodiment of the present invention it is provided that the plate has a thickness T and the half of the difference between the inner diameter Di and the outer diameter Do is smaller than the thickness T of the plate.

In another preferred embodiment of the present invention it is provided that the inner side of the protuberance is designed such that a maximal difference ΔDi between the first inside diameter Di′ and the second inside diameter Di″ corresponds to ΔDi=DIS*tan α, wherein a tilt angle α is around 1° and DIS is the distance between the first plane and the second plane (, i.e. DIS=|Di′−Di″|). The tilt angle α is a measure how much the inner side of the protuberance is tapered compared to a cylindrical shaped protuberance, which is known from the prior art. It is also conceivable, that the tilt angle α changes along the extension of the protuberance, in particular the tilt angle changes gradually. By this it may be possible to optimize the fastening properties with respect to the frictional or positively locking means provided for the fastening means individually.

In another preferred embodiment of the present invention it is provided that the fastening means has a throat section that at least partially forms a circle segment with a circle radius R in a plan being perpendicular to the main plane. Further it is provided that the throat section links the prime surface of the plate with the inner side of the protuberance mainly and the throat section comprises a circle segment with a circle radius R corresponding to R=0.33*T, substantially. Advantageously the smaller throat section allows reducing the required distance between two fastening means whenever several fastening means according to the present invention are arranged in an assembly of fastening means.

In another embodiment if is provided that the fastening means has a protuberance height H corresponding to the distance between the plane that includes the prime surface and the plane being parallel to the main plane that includes the part of the protuberance located furthermost relative to the plane that includes the prime surface. In particular, it is provided that the protuberance height H is smaller than any inside diameter Di of the protuberance.

Compared to protuberances with a height greater than the inside diameter, fewer station of manufacturing are needed for producing the fastening means with such short protuberances. Therefore tooling costs and processing time can be reduced, advantageously.

In another preferred embodiment of the present invention the protuberance height is designed such that the frictional and/or positively locking mean exits the protuberance provided that the frictional or positively locking mean is engaged with the protuberance in a frictional or positively locking fashion. It is an advantage of this embodiment, that the fastening means is compatible with several friction or positively locking means, in particular several friction or locking means having different length. As a result the fastening means is flexible in use and not limited to one special kind of friction or positively locking means.

In another embodiment the change of the diameter ΔDi and/or the throat diameter and/or the height H vary due to engineering and/or manufacturing purposes. It is an advantage of the present invention that the fastening means can be used in a wide field of applications because the function of the fastening means is already realized by a small protuberance. Thus it is possible in an advantageous way to adapt the fastening means to the environment the fastening means is provided for. In contrast to this the use of fastening means known from the prior art are sometimes limited by their surroundings.

In addition the present invention includes an assembly of several fastening means, wherein several fastening means are arranged on one common plate. In particular, it is provided that the assembly of the fastening means are manufactured using a press and several dies for realizing the assembly in one step. It is also convincible that an assembly of fastening means is generated in a first process and subsequently the assembly is divided into several small units that comprises at least one fastening means. Thus it is advantageously possible to increase the number of such units (having the fastening means according to the present invention) that are manufactured per unit time.

Additionally the present invention includes also a method for generating fastening means as described above. It is provided that the method according to the present invention comprises an extrusion process for forming the protuberance. More specifically, a die produce the protuberance in combination with a press mean, like a hydraulic press for example. Actually the method is not restricted to cold extrusion. Other extrusion processes, like hot extrusion, are also conceivable.

### EMBODIMENTS OF THE PRESENT INVENTION

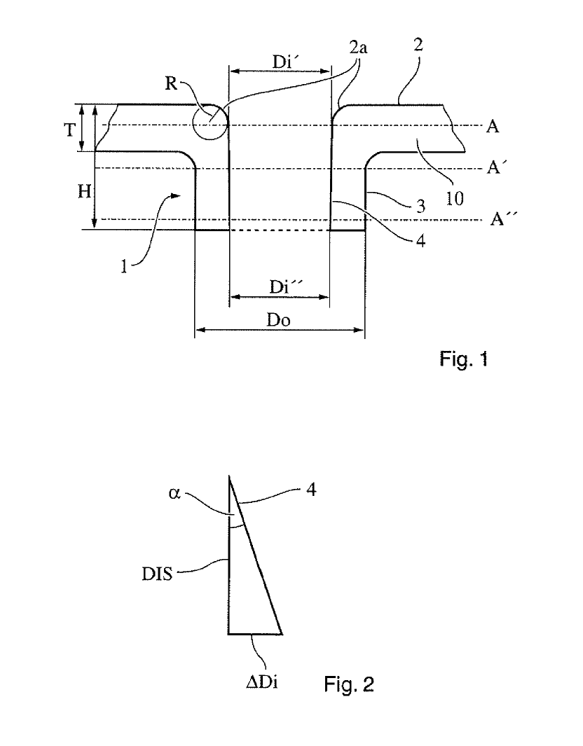

FIG. 1 shows a sectional view of a fastening means according to an embodiment of the present invention, wherein a protuberance projects from a plate 10 with a thickness T and comprises both an inner side 4 and an outer side 3. Mainly the inner side 4 and the outer side 3 of the extrusion form a wall that is able to receive frictional or positively locking means such as a screw. In particular, the inner side is provided for contacting frictional or positively locking means and thus realizing the positive locking and or the frictional locking. Usually the interior of the protuberance formed by the inner side of the extrusion is shaped like a cylinder, substantially.

in detail FIG. 1 illustrates that the plate 10, which expands across a main plane A, has a prime surface 2 facing away from the protuberance. It is provided that the prime surface passes over to the inner side of the extrusion via a throat section 2a. The throat section 2a is designed such that a circle segment is at least partially expanding in a plane perpendicular to the main plain A. The curvature of the circle segment is specified by a radius R wherein the radius R corresponds to the circle illustrated as dotted line in FIG. 1. The height H of the extrusion reaches from the plane including the prime surface 2 to the plane that is parallel to the main plane (therefore usually also being parallel to the prime surface) and that includes a part of the protuberance being located furthermost from the plane that includes the prime surface.

Both the inner side and the outer side of the extrusion form circles in planes being parallel to the main plain A respectively, wherein the inner side 4 forms a circle with an inside diameter Di and wherein the outer side 3 forms a circle with an outer diameter Do. As depictured in FIG. 1 the inner diameter Di is smaller than the outer diameter Do. According to the present invention it is provided that a first inside diameter Di′ in a first plane A′ is greater than a second diameter Di″ in a second plane A″, wherein both the first and the second plane A′ and A″ are parallel to the main plane and the first cross section A′ is located closer to the prime surface 2 than the second cross section A″. Designing the protuberance 1 like that, It is possible to reduce the height H of the extrusion 1. In particular, it is advantageously possible to realize an extrusion 1 for engaging with positively locking means, wherein the height H of protuberance is smaller than the inside diameters Di along the protuberance.

FIG. 2 shows the geometrical fundaments for describing a tilt that is realized whenever a protuberance is designed according to the present invention. Such a tilt is observable in the case of looking at the extrusion, especially at the inner side 4 of the extrusion, along a direction being parallel to the main plan. The tilt of the inner side of the extrusion relative to a plane being perpendicular to the main plane can be determined by a tilt angle α. The tilt angle α defines the difference ΔD between the first inside diameter Di′ and the second inside diameter Di″ in dependence on the distance DIS between the first plane A′ and the second plane A″. In particular, if is provided that ΔD equals DIS*tan α.

### LIST OF REFERENCES

1 protuberance

2 prime surface

2a throat section

3 outer side

4 inner side

10 plate

A main plane

A′ first plane being parallel to main plane

A″ second plane being parallel to main plane

T Thickness of the plate

H protuberance height

Di inside diameter

Do outside diameter

Di′ first inside diameter

Di″ second inside diameter

1. A fastening means provided for engaging with frictional or positively locking means in a friction or positively locking fashion comprising:
a protuberance realized as an extrusion, wherein the protuberance:
projects from a plate expanding along a main plane and having a prime surface facing away from the protuberance and
comprises an inner side, wherein the inner side forms a circle having an inside diameter Di in a plane being parallel to the main plane,
wherein a first plane being parallel to the main plane includes a circle with a first inside diameter Di′ and a second plane being parallel to the main plane includes a circle with a second inside diameter Di″, wherein the first plane is closer to the prime surface than the second plane and wherein the first inside diameter Di′ is greater than the second inside diameter D1″.

2. The fastening means as claimed in claim 1, wherein the protuberance has an opening.

3. The fastening means as claimed in claim 1, wherein the plate has a thickness T and half of the difference between the inside diameter Di and an outer diameter Do is smaller than the thickness T of the plate.

4. The fastening means as claimed in claim 1, wherein a maximal difference ΔDi between the first inside diameter Di′ and the second inside diameter Di″ corresponds to ΔDi=DIS*tan α, wherein a tilt angle α is 1° substantially and DIS is the distance between the first plane and the second plane.

5. The fastening means as claimed in claim 1, wherein the fastening means has a throat section that at least partially forms a circle segment with a circle radius R in a plane being perpendicular to the main plane, wherein the throat section links the prime surface of the plate with the inner side of the protuberance and wherein the throat section comprises a circle segment with a circle radius R corresponding to R=0.33*T.

8. The fastening means as claimed in claim 1, wherein the fastening means has a protuberance height H corresponding to a distance between the plane that includes the prime surface and the plane being parallel to the main plane that includes the part of the protuberance located furthermost relative to the plans that includes the prime surface, wherein the protuberance height H is smaller than any inside diameter Di of the protuberance.

7. The fastening means as claimed in claim 1, wherein the fastening means has a protuberance height H and protuberance height H is designed such that the frictional and/or positively locking mean exits the protuberance provided that the frictional or positively locking mean is engaged with the protuberance in a frictional or positively locking fashion.

8. The fastening means as claimed in claim 1, wherein a change of the diameter ΔDi between the first inside diameter Di′ and the second inside diameter Di″ and/or a throat diameter and/or a protuberance height H vary due to engineering and/or manufacturing purposes.

9. An assembly comprising several fastening means according to claim 1, wherein several fastening means are arranged on one common plate.

10. A method for generating a fastening means according to claim 1, wherein the method comprises an extrusion process.
